(19) United States
(12) Patent Application Publication
(10) Pub. No.: US 2008/0069459 A1
(43) Pub. Date: Mar. 20, 2008

(54) Estimation of image motion, luminance variations and time-varying image aberrations

(76) Inventor: Stefano Casadei, Cambridge, MA (US)

Correspondence Address: STEFANO CASADEI, 71 RUE DU CARDINAL LEMOINE, PARIS, 75005, FR

(21) Appl. No.: 11/857,842

(22) Filed: Sep. 19, 2007

Related U.S. Application Data
(60) Provisional application No. 60/826,115, filed on Sep. 19, 2006.

(51) Int. Cl. G06K 9/36

(52) U.S. Cl. 382/236; 382/248

(57) ABSTRACT

A method is disclosed to jointly estimate genuine image motion, luminance variations, and time-varying image aberrations. The method takes into account in a natural way the dependence of image aberrations both on spatial coordinates and spatial frequency. A novel hybrid model of image aberrations is introduced which combines a frequency domain constraint with linearization in the spatial domain. A search is performed for homogeneous data blocks delimited in space, time and spatial frequency in which image aberrations are well described by a low-order model. A windowed Fourier transform is used to convert the input data into a representation that is suitable for this type of hybrid modeling. A local linear parametrization of image changes is introduced, leading to a fast linear estimation algorithm.

### REFERENCE TO RELATED APPLICATIONS

This application claims the benefit of U.S. Provisional Patent Application 60/826,115, filed Sep. 19, 2006, entitled “Estimation and interpretation of image changes via FFTs”, by the same inventor as this application.

The U.S. Government has a paid-up license in this invention and the right in limited circumstances to require the patent owner to license others on reasonable terms as provided for by the terms of contract No. F29601-01-C-0008 awarded by the U.S. Air Force, Kirtland AFB, NM.

### FIELD OF THE INVENTION

This invention relates to the field of image processing. More specifically, this invention relates to methods and systems to detect, estimate and classify image changes over time, including time-varying image aberrations, by means of signal transforms, such as the windowed Fourier transform.

### BACKGROUND OF THE INVENTION

Many image processing tasks, such as surveillance, object tracking, navigation, scene understanding, etc., need to detect, estimate and classify image changes over time caused by a variety of physical phenomena such as motion of objects in the scene relative to the imaging sensor, changes of the sensed luminance of the visible areas in the scene, and random fast-changing image aberrations induced, for example, by turbulence in the light propagation medium.

While several methods are known for the estimation of image motion [1], only relatively few methods exist that are applicable to imagery corrupted by time-varying (and space-varying) image aberrations. These methods [10, 8] are based on approximating these image aberrations as random space-varying and time-varying local displacements in the image plane. This approximation neglects the dependence on spatial frequency of common types of image aberrations [2]. Because the existing methods for the joint estimation of genuine image motion (induced by physical changes in the scene) and time-varying image aberrations do not take into account this dependence on spatial frequency, they are forced to low-pass the image data so that all but few spatial frequencies are removed from the signal and the underlying assumption is thus satisfied. This leads to deteriorated performance, especially when high spatial frequencies are predominant (e.g. in textured images).

One approach to deal with the dependence of image aberrations on spatial frequency is to utilize a Fourier transform method. Indeed, the most successful methods to mitigate image aberrations [2, 3] operate in the Fourier domain. However, most existing Fourier based methods assume a stationary scene where the image data does not contain any image changes other than those due to image aberrations. Or, they deal with genuine image motion and image aberrations as two independent problems [5]. Furthermore, while the Fourier-transformed data “exposes” the dependence on spatial frequency, it “conceals” the dependence on spatial coordinates so that many existing Fourier methods can be applied only when image aberrations are known to be spatially homogenous throughout the whole image plane [2] or within large regions of the image plane [3].

Finally, most of the known methods are based on a luminance constancy constraint (see equation (3) below) which is often violated in practice.

Hence, a method is needed to jointly estimate genuine image motion, luminance variations, and time-varying image aberrations which takes into account in a natural way the dependence of these aberrations both on spatial coordinates and spatial frequency. This invention addresses this need by introducing a novel hybrid model of image aberrations which combines a frequency domain constraint with linearization in the spatial domain. This leads to the search of homogeneous data blocks delimited in space, time and spatial frequency in which image aberrations are well described by a low-order model.

A multiresolution windowed Fourier transform is used to convert the input data into a representation that is suitable for this type of hybrid modeling. A local linear parametrization of image changes is introduced, leading to a fast linear estimation algorithm.

### BRIEF DESCRIPTION OF THE DRAWINGS

FIG. 1 illustrates an embodiment of the invention for the estimation of time-varying image aberrations in a stationary scene where genuine image motion and luminance changes are absent or negligible.

FIG. 2 illustrates a second embodiment of the invention, where genuine image motion and luminance variations are estimated along with time-varying aberrations. In this embodiment, a recursive filter is used to track the estimated image changes over time.

### DESCRIPTION OF THE INVENTION

### Image Changes Due to Genuine Motion and Luminance Variations

Let x=(x₁,x₂) be a continuous two-dimensional coordinate of the image plane and t continuous time. In usual imaging system, such as the perspective camera model, to any image point x there correspond at any time t a three-dimensional (3-D) point in physical space, which will be denoted P(x,t). If e(P,t) is the luminance of the 3-D point P at time t, then the underlying time-varying image intensity is given by:
ũ(x,t)=e(P(x,t),t). (1)

If a physical 3-D point is visible for an interval of time, then its associated image point traces out a trajectory γₜx in the image plane where x is its image at time t=0. We have then:
P(γₜx,t)=P(x,0). (2)
The “genuine” image motion described by these trajectories (to be distinguished later from the image motion caused by time-varying image aberrations) is caused by the relative motion of the objects and surfaces in the scene and the imaging sensor.

One common assumption (which is however often violated in practice) is that luminance of physical points is constant: e(P,t)=e(P, 0), ∀t, so that
ũ(x,t)=ũ(γₜ⁻¹x,0). (3)
More generally, when luminance changes (for example, due to reflactance or orientation changes of the visible surfaces or motion of the illumination sources), we have the expression:
ũ(x,t)=\tilde{e}(γₜ⁻¹x,t), (4)
where \tilde{e}(x,t)=e(P(x,0),t) is the luminance at time t of the 3-D point P(x,0). This general formula, which applies when there are no image aberrations, separates the image changes due to genuine motion, represented by the trajectories γₜx, from those due to luminance changes, represented by the function \tilde{e}. The constant luminance constraint, often assumed by many existing methods, is obtained when \tilde{e} does not depend on time. By letting v^{g}(x,t)=\dot{γ}ₜ(γₜx), \dot{γ}ₜ=∂/∂tγₜ, be the velocity field associated with genuine image motion and l^{g}=∂/∂te be the rate of genuine luminance change, we have
dũ(x,t)=−(v^{g}(x,t)∇ũ(x,t))dt+l^{g}(x,t)dt. (5)

### Modeling Time-Varying Image Aberration

To avoid the shortcomings of aberration models formulated in the spatial domain and those formulated in the frequency domain, we introduce a hybrid model where the underlying image is projected into blocks containing a limited range of frequencies and the effect of aberrations is described as a random translation in the spatial domain, where the amount of translation is constant within a block (or described by a low-order model) but it may vary from block to block, hence allowing image aberrations to depend on frequency. In addition, a random amplification factor is introduced in the model. Let F denote a range of spatial frequencies and let ũ_{F} be a filtered image from which (essentially) all spatial frequencies but those in F have been removed. The invention described here is based on the following model of image aberrations:
dũ_{F}(x,t)=−[v^{g}(x,t)+v^{a}(F,x,t)]∇ũ_{F}(x,t)dt+[l^{g}(x,t)+ε(F,x,t)ũ_{F}(x,t)]dt, (6)
where v^{a}(F,x,t)dt and ε(F,x,t)dt are the aberration induced displacement and amplification respectively. This expression can be written as:
dũ_{F}(x,t)=−v(F,x,t)∇ũ_{F}(x,t)dt+l(F,x,t)dt, (7)
where v(F,x,t)dt is the overall image motion (genuine plus induced by aberrations) and l(F,x,t)=l^{g}(x,t)+ε(F,x,t)ũ_{F}(x,t) is the overall rate of luminance variation.

### The Windowed Fourier Transform

According to one aspect of the invention, the 3-D array of image values (2-D space×1-D time) is converted into a representation that is suitable to represent the dependency of image aberrations on both spatial coordinates and spatial frequency. In typical embodiments, this representation consists of the coefficients of windowed Fourier transforms calculated over a collection of rectangular regions of different sizes. We denote by p=(p₁,p₂) and L=(L₁,L₂) the center and size of one of these regions. We assume that L₁ and L₂ are even integers, (p₁, p₂) is a pair of integers corresponding to a pixel location in the image, and the region contains (L₁+1)·(L₂+1) pixels (L₁ and L₂ are the distances between the first and last rows and columns of the images, respectively). The transformed signal is then denoted q_{L,p}(f,t), where f=(f₁, f₂) is spatial frequency, ranging over a finite set of values, and t is time, also ranging over a discrete set of values.

Inferring the Continuous Underlying Image

In some embodiments, the signal transform is obtained (conceptually) through three stages:
o→ũ→u→q. (8)
Here, o=(o_{r,c,t}), r=1, . . . , N, c=1, . . . , N, t=1, . . . , Nₜ is the input 3-D array of observations. The first step is to obtain an estimate of the underlying continuous image ũ(•,t) from the input array o. In general, this inferential step can take into account specific information such as characteristics of the sensor array, a-priori knowledge about the scene, etc. A simple approach to perform this step is based on the following two sub-steps. First, in the spatial domain, each image frame o_{•,•,t} is extrapolated to [symbol] (the set of all integer pairs). For example, this can be done by zero-padding (if the average value of o is zero). Secondly, we assume that the Nyquist condition is satisfied, that is, that ũ has bandwidth [−0.5, 0.5]:
|f₁|≧0.5V|f₂|≧0.5ℑ(ũ)(f)=0, (9)
where ℑ denotes the Fourier transform operator:

$$ℱ ( \tilde{u} ) ( f ) = \int {ⅇ}^{- j 2 π fx} \tilde{u} ( x ) ⅆ x = \int {ⅇ}^{- j 2 π ( {f}_{1} {x}_{1} + {f}_{2} {x}_{2} )} \tilde{u} ( {x}_{1} , {x}_{2} ) ⅆ {x}_{1} ⅆ {x}_{2} . \qquad ( 10 )$$

With these two assumptions, an estimate of the underlying image ũ(•,t) is given by the sinc-interpolation formula:

$$\tilde{u} ( x , t ) = {\sum }_{{x}_{1}^{′} εZ} {\sum }_{{x}_{2}^{′} εZ} \frac{sin π ( {x}_{1}^{′} - {x}_{1} )}{π ( {x}_{1}^{′} - {x}_{1} )} \frac{sin π ( {x}_{2}^{′} - {x}_{2} )}{π ( {x}_{2}^{′} - {x}_{2} )} {o}_{{x}_{1}^{′} , {x}_{2}^{′} , t ;} x = ( {x}_{1} , {x}_{2} ) ε {R}^{2} . \qquad ( 11 )$$

Discretization

In the second step of (8), for computational reasons, the underlying image is discretized both in the spatial domain and in the spatial-frequency domain so that Fast Fourier Transform algorithms (FFT) can be used to calculate the windowed Fourier coefficients. This yields the discretized underlying image, denoted u and given by:
u=S_{ν}_{ₛₚ}_{^{−1}}(S_{Nν}_{_{fr}}*ũ), (12)
where νₛₚ and ν_{fr} are positive integers representing spatial and frequency oversampling factors and S_{α} denotes a sequence of 2D-impulses with sampling distance equal to α:

$${S}_{a} ( {x}^{′} ) = {\sum }_{{x}_{1} εZ} {\sum }_{{x}_{2} εZ} {δ}_{a {x}_{1}} ( {x}_{1}^{′} ) {δ}_{a {x}_{2}} ( {x}_{2}^{′} ) , \qquad ( 13 )$$

and * denotes convolution. Notice that in the frequency domain we have:
ℑ(u)=S_{ν}_{ₛₚ}*(S_{(Nν}_{_{fr}}₎_{^{−1}}ℑ(ũ)). (14)
Notice that the effect of the frequency domain sampling, is to replicate the underlying image with a period equal to the size of the image times ν_{fr}. This introduces errors near the edges of the image. Thus, oversampling in the frequency domain (ν_{fr}>1) is important only to mitigate boundary effects. For simplicity, we describe embodiments where ν_{fr}=1 and boundary effects are reduced by considering regions sufficiently inside the image domain. This makes the function u periodic with period (N,N) (circular filtering). This also makes u independent of the extrapolation method. To simplify the notation further we let ν=νₛₚ. We will show later that by using cos²(•) window function an oversampling factor of ν=2 in the spatial domain is sufficient to eliminate most of the approximation errors due to discretization.
Calculating the Windowed Fourier Transform

The computed windowed Fourier transform is given by:
q_{L,p}(f,t)=ℑ(w_{L}·τ₋ₚu(•,t)(f)=<ψ_{L,p,f},u(•,t)>, (15)
where
w_{L} is a window function, for example, obtained by truncating and scaling the function cos²(πx₁)cos²(πx₂);
τ denotes the translation operator: τ₋ₚu(x,t)=u(x+p,t);
<•,•> denotes the inner product in L² [symbol]
   <g,h>=∫g*(x)h(x)dx, x=(x₁,x₂)ε [symbol] (16)
and ψ_{L,p,f} is the scaled and translated wavelet corresponding to the windowed Fourier component of frequency f:
ψ_{L,p,f}(x)=ψ_{L}_{₁}_{,p}_{₁}_{,f}_{₁}(x₁)ψ_{L}_{₂}_{,p}_{₂}_{,f}_{₂}(x₂). (17)
That is,

$${ψ}_{L , p , f} ( x ) = \frac{1}{{L}_{1}} \frac{1}{{L}_{2}} w ( \frac{{x}_{1} - {p}_{1}}{{L}_{1}} ) w ( \frac{{x}_{2} - {p}_{2}}{{L}_{2}} ) {ⅇ}^{j 2 π {f}_{1} ( {x}_{1} - {p}_{1} ) + {f}_{2} ( {x}_{2} - {p}_{2} )} , \qquad ( 18 )$$

where, for example, for α=1, 2,

$$w ( {x}_{a} ) = \{ \begin{matrix}{cos}^{2} ( π {x}_{a} ) , & if \vert {x}_{a} \vert \leq 0.5 \\ 0 , & if \vert {x}_{a} \vert \geq 0.5 .\end{matrix} \qquad ( 19 )$$

Local Frequency-Based Representation of the Image Data

This subsection describes what frequency values are required to obtain a local Fourier representation of the image data. For simplicity, the 1-D case where f=f₁, L=L₁, etc. is considered. For a given value of L, the maximum frequency response of each wavelet outside the frequency band [f−2/L,f+2/L] is about 2% of the peak response when the window function (19) is used. If we tolerate this approximation error, and since we assumed that the underlying image has bandwidth [−½,½], then only wavelet of frequencies in the band [−½−2/L,½+2/L] need to be considered, the others yielding a negligible value. Then a local representation is obtained by using the following frequency values:

$${f}_{k} = \frac{1}{L} ( - \frac{{L}^{′}}{2} + k - 1 ) , k = 1 , … , {L}^{′} + 1. \qquad ( 20 )$$

where L′=L+2. By assuming that L is even, this results in the sequence of frequency values:

$${F}^{max} ( L ) = \frac{1}{L} ( - \frac{{L}^{′}}{2} , - \frac{{L}^{′} + 1}{2} , … , 0 , … , \frac{{L}^{′} - 1}{2} , \frac{{L}^{′}}{2} ) . \qquad ( 21 )$$

Embodiments of the invention construct homogeneous blocks by selecting adjacent frequency values from F^{max}(L).
Upsampling Rate

We argue that an oversampling factor of ν=2 is sufficient to keep the errors due to discretization small so that q_{L,p}(f,t)≅\tilde{q}_{L,p}(f,t). Indeed, if ν=2, the Fourier transform of u is obtained by replicating the Fourier transform of ũ at frequency intervals of ν=2. Since we assumed that the support of ℑ(ũ) is contained in [−0.5, 0.5], ℑ(u) is zero at frequencies f such that 0.5≦|f|≦1.5. Therefore, only the wavelet Fourier transform at frequencies f≧1.5 picks up the distortion due to discretization. All the wavelets are negligible in this range of frequencies, which makes them immune to discretization as long as ν≧2.

### Estimation of Aberrations in a Stationary Scene

An embodiment of the invention for the estimation of time-varying image aberrations in a stationary scene where genuine image motion and luminance changes are absent or negligible is now described. Under these assumptions and the additional assumption that luminance variations due to image aberrations can be neglected as well, the model of time-varying image aberrations described earlier yields:
ũ(x,t)= u̅(x+ξ), (22)
where u̅ is the underlying stationary image and ξ is a displacement vector dependent on t, x and f which represents image aberrations.

To obtain a linear estimation problem, consider the first order variation of the windowed Fourier coefficients due to the displacement ξ:
d\tilde{q}_{L,p}(f,t)=<ψ_{L,p,f},∇ u̅>ξ=<−∇ψ_{L,p,f}, u̅>ξ, (23)
where we have used integration by parts and the fact that the integrand is zero on the boundary of the support of ψ_{L,p,f}. By noting that

$$∇ {ψ}_{L , p , f} ( x ) = \frac{1}{{L}_{1} {L}_{2}} {ⅇ}^{j 2 π ( x - p ) f} [ j 2 π fw ( \frac{x - p}{L} ) + ∇ w ( \frac{x - p}{L} ) ] , \qquad ( 24 )$$

one gets
d\tilde{q}_{L,p}(f,t)=[−j2π q̅_{L,P}⁰(f)f+ q̅_{L,p}¹(f)]ξ(t) (25)
where the dependence of ξ on t has been made explicit and:
q̅_{L,p}⁰(f) and q̅_{L,p}¹(f)=( q̅_{L,p}^{1,1}(f), q̅_{L,p}^{1,2}(f)) are the scalar and vector Fourier coefficients, respectively, associated with the underlying stationary scene u̅:
   q̅_{L,p}⁰(f)=<ψ_{L,p,f}, u̅>
   q̅_{L,p}¹(f)=<ψ_{L,p,f}, u̅) (26)
ψ_{L,p,f}¹=(ψ_{L,p,f}^{1,1},ψ_{L,p,f}^{1,2}) is the wavelet vector given by:
ψ_{L,p,f}¹=(ψ_{L,p f}^{(1,0)},ψ_{L,p,f}^{(0,1)}) (27)
where ψ_{L,p,f}^{(m}^{₁}^{,m}^{₂}⁾ is given by the formula:

$${ψ}_{L , p , f}^{m} ( x ) = \frac{1}{{L}_{1} {L}_{2}} {ⅇ}^{j 2 π ( x - p ) f} {\prod }_{a = 1}^{2} {( \frac{\partial }{\partial {x}_{a}} )}^{{m}_{a}} w ( \frac{{x}_{a} - {p}_{a}}{{L}_{a}} ) , m = ( {m}_{1} , {m}_{2} ) . \qquad ( 28 )$$

Note that ψ=ψ^{(0,0)}, ψ^{1,1}=ψ^{(1,0)}, ψ^{1,2}=ψ^{(0,1)}, and similarly for the coefficients q.

By noting that \tilde{q} reduces to q̅ for ξ=0, and by replacing the continuous-domain quantities with their discretized counterparts, the linearized approximation (25) for the observed Fourier coefficients q becomes

$${q}_{L , p}^{0} ( f , t ) - {\overline{q}}_{L , p}^{0} ( f ) ≃ {[ \begin{matrix}- j 2 π {\overline{q}}_{L , p}^{0} ( f ) {f}_{1} + {\overline{q}}_{L , p}^{1 , 1} ( f ) \\ - j 2 π {\overline{q}}_{L , p}^{0} ( f ) {f}_{2} + {\overline{q}}_{L , p}^{1 , 2} ( f )\end{matrix} ]}^{t} [ \begin{matrix}{ξ}_{1} ( t ) \\ {ξ}_{2} ( t )\end{matrix} ] = {\sum }_{α = 1}^{2} H ( f , α ) ξ ( α , t ) \qquad ( 29 )$$

where ξ(t)=(ξ₁(t),ξ₂(t))=(ξ(1,t),ξ(2,t)) and
H(f,α)==−j2π q̅_{L,p}⁰(f)f_{α}+ q̅_{L,p}^{1,α}(f), α1,2. (30)
In one embodiment, the coefficients q̅_{L,p}⁰(f) and q̅_{L,p}^{1,α}(f) are obtained by time-averaging the corresponding coefficients.

The above equation (29) can be written in matrix form by assigning the row index to frequencies and the column index to time:

$$Q ( F , T ) - \overline{Q} ( F ) ≃ {\sum }_{α = 1}^{2} H ( F , α ) ξ ( α , T ) , \qquad ( 31 )$$

where F⊂F^{max} (L) denotes a selected set of frequency values and T a selected set of time values. By introducing a third axis for the parameter oz, one obtains the more compact expression:
Q(F,T)− Q̅(F)≅H(F,A)ξ(A,T), (32)
where A={1,2}. From this, an estimate of the translation vector can be obtained by:
\hat{ξ}(A,T)=(H_{R}^{t}(F,A)H_{R}(F,A))⁻¹H_{R}^{t}(F,A)(Q_{R}(F,T)− Q̅_{R}(F)), (33)
where H_{R}, Q_{R} and Q̅_{R} are the real matrices obtained by separating the real and imaginary components of H, Q and Q̅ into separate rows, so as to ensure that the resulting estimate is real.

The parameters L, p, F, T specify a data block delimited in space, time and spatial frequency. According to one aspect of the invention, the estimation method searches for data blocks that are homogeneous, that is, where the assumed underlying model provides a good fit to the observed data.

Let P be the set of image pixels specified by L, p. Note that the windowed Fourier transformation for the data block (P,T,F) can be written compactly as:
u(P,T)→q(F,T)=W(F,P)u(P,T) (34)
where u(P,T) is the upsampled image over the image points P, and W(F,P) is a matrix representation of the wavelet bank.
Flowchart of the Method

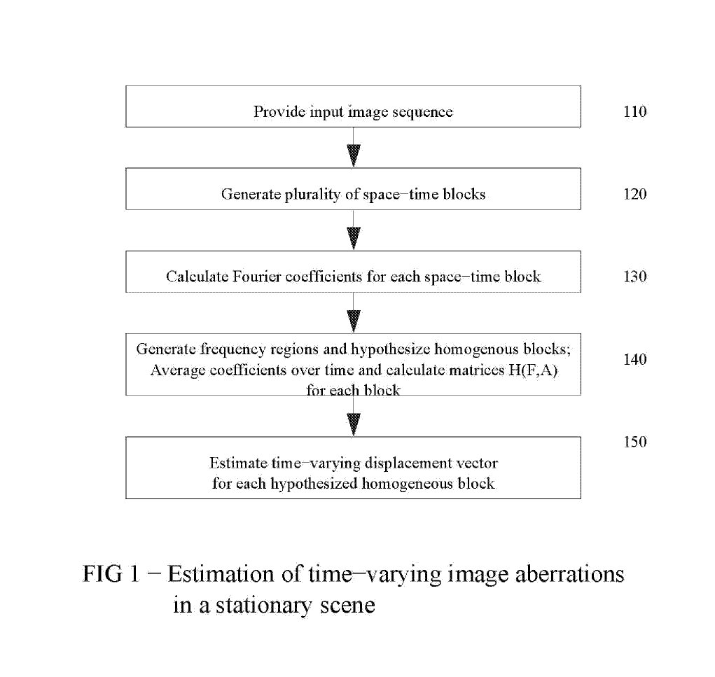

The flowchart in FIG. 1 describes this particular embodiment of the invention. At step 110 an image data sequence is provided. At step 120, a plurality of space-time data blocks is obtained by selecting multiple values of the parameters L, p and T, where T denotes a time interval identifying a subset of image frames. Values for L=(L₁,L₂) are selected based on how much image aberrations are expected to vary within the image. Small values of L_{α}, α=1, 2, are required to obtain homogeneous blocks when image aberrations vary rapidly in space. However, a minimum value for L_{α} of 8 pixels is recommended. On the other hand, larger blocks yield a better signal to noise ratio when the spatial correlation length of the image aberrations is larger. Thus, in typical embodiments, multiple values of L_{α} (e.g., L_{α}=8, 16, 32, . . . ) are used in order to find the optimal scale at which to estimate the image aberrations. For each L_{α} the block spatial centers p_{α} are typically chosen at intervals of width L_{α}/2. The time interval T can be chosen to be large, as long as the image data is known to satisfy the underlying assumption. Otherwise, multiple choices for T should be tried.

Step 130 calculates the Fourier coefficients q_{L,p}(f,t), q_{L,p}¹(f,t), etc. for all the image regions obtained from step 120.

Step 140 generates a plurality of frequency regions F by selecting adjacent frequency values from F^{max}(L). In each block specified by a particular choice for L, p, T and F it is hypothesized that the image aberrations are described a time-varying displacement vector ξ(t). The Fourier coefficients relative to the hypothesized block are stacked together and time averaged, and the matrix H(F,A) of (30)-(32) is obtained.

Finally, step 150 calculates an estimate of ξ(t) by means of equation (33) and may perform additional tests to validate the underlying hypothesis.

### MORE GENERAL EMBODIMENT

A second embodiment is now described where genuine image motion and luminance variations are estimated along with time-varying aberrations. In this embodiment, a recursive filter is used to track the estimated image changes over time. A parametric model for image changes which contains first-order terms in spatial coordinates is used to illustrate how the proposed method can incorporate models of image variations of varying complexity into the notion of “homogeneous” blocks.

When the image model (6)-(7) is projected on windowed Fourier wavelets of the form ψ_{R,f}(x)=R(x)e^{j2πfx}, after integration by parts in the image domain (using the fact that the window function R(x) has compact support) one obtains the following dynamical equation for the windowed Fourier coefficients:

$$\frac{\partial }{\partial t} {q}_{R , f} ( t ) = - j 2 π f 〈 {ψ}_{R , f} , u ( \cdot , t ) v ( f , \cdot , t ) 〉 + 〈 {ψ}_{\partial R , f} , u ( \cdot , t ) v ( f , \cdot , t ) 〉 + 〈 {ψ}_{R , f} , u ( \cdot , t ) div v ( f , \cdot , t ) 〉 + 〈 {ψ}_{R , f} , l ( f , \cdot , t ) 〉$$

where q_{R,f}(t)=<ψ_{R,f},u(•,t)> and ψ_{∂R,f}(x)=∇R(x)e^{j2πfx} is the wavelet vector analogous to (27)-(28).

For simplicity of notation, we now assume that suitable preprocessing of the input data has been performed so that we can neglect the distinction (see (8)) between the underlying continuous image ũ and its associated coefficients q on one hand, and the corresponding discretized quantities u, q, etc. on the other hand.

Polynomial Models of the Velocity Field and the Luminance Variations

The proposed approach to estimate and characterize image changes is to search for data blocks specified by an image region R and a set of frequency values F in which image changes can be described by simple models. One class of such models is polynomial functions of low degree. For example, one can assume that the total velocity field (including genuine motion and the effects of time-varying aberrations) is constant inside an image region (0-th order polynomial) or that it varies linearly with x (1-st order polynomial):
v(f,x)≈v⁰+v¹x, (36)
where v⁰=(v₁,v₂)^{T} and v¹ is a 2×2 matrix. Here, for simplicity, we have dropped the dependence on t from the notation. In order for this approximation to be valid, the underlying velocity field must be smooth and the image region must be sufficiently small. By substituting v(f,x,t)=v⁰ in (35) one obtains that the contribution of v⁰ to the first three terms of (35) is:
−j2πf·v⁰q_{R,f}+v⁰·q_{R,f}¹ (37)
where q_{R,f}¹=<ψ_{R,f}¹,u>, in accordance with (27)-(30).

In typical embodiments the window function R(x) is separable and given by:

$$R ( x ) = w ( \frac{{x}_{1} - {p}_{1}}{{L}_{1}} ) w ( \frac{{x}_{2} - {p}_{2}}{{L}_{2}} ) . \qquad ( 38 )$$

For each value of the parameters L, p, f, one obtains the following equation:

$$\frac{\partial }{\partial t} {q}_{L , p , f} ( t ) = {H}_{L , p , f}^{mot} ( t ) \underline{v} ( t ) + {H}_{L , p , f}^{lum} ( t ) \underline{l} ( t ) = {H}_{L , p , f} ( t ) ϕ ( t ) , \qquad ( 39 )$$

where H_{L,p,f}(t)=(H_{L,p,f}^{mot}(t), H_{L,p,f}^{lum}(t)) and φ(t)=(v(t)^{T},l(t)^{T})^{T}. By defining (in analogy with, as a generalization of (28)):

$${q}_{L , p , f}^{s , m , n} = \int {( \frac{\partial }{\partial {x}_{1}} )}^{{m}_{1}} {( \frac{\partial }{\partial {x}_{2}} )}^{{m}_{2}} w ( \frac{{x}_{1} - {p}_{1}}{{L}_{1}} ) w ( \frac{{x}_{2} - {p}_{2}}{{L}_{2}} ) {x}_{1}^{{n}_{1}} {x}_{2}^{{n}_{2}} {u}^{s} ( x ) {ⅇ}^{- j 2 π f \cdot x} ⅆ x ,$$

the image dynamics due to image motion can be expressed as:

$${H}_{L , p , f}^{mot} \underline{v} = {( \begin{matrix}- j 2 π {f}_{1} {q}_{L , p , f}^{1 , 0 , 0} + {q}_{L , p , f}^{1 , {δ}_{1} , 0} \\ - j 2 π {f}_{2} {q}_{L , p , f}^{1 , 0 , 0} + {q}_{L , p , f}^{1 , {δ}_{2} , 0} \\ - j 2 π {f}_{1} {q}_{L , p , f}^{1 , 0 , {δ}_{1}} + {q}_{L , p , f}^{1 , {δ}_{1} , {δ}_{1}} + {q}_{L , p , f}^{1 , 0 , 0} \\ - j 2 π {f}_{1} {q}_{L , p , f}^{1 , 0 , {δ}_{2}} + {q}_{L , p , f}^{1 , {δ}_{1} , {δ}_{2}} \\ - j 2 π {f}_{2} {q}_{L , p , f}^{1 , 0 , {δ}_{1}} + {q}_{L , p , f}^{1 , {δ}_{2} , {δ}_{1}} \\ - j 2 π {f}_{2} {q}_{L , p , f}^{1 , 0 , {δ}_{2}} + {q}_{L , p , f}^{1 , {δ}_{2} , {δ}_{2}} + {q}_{L , p , f}^{1 , 0 , 0}\end{matrix} )}^{T} ( \begin{matrix}{v}_{1} \\ {v}_{2} \\ {v}_{1 , 1} \\ {v}_{1 , 2} \\ {v}_{2 , 1} \\ {v}_{2 , 2}\end{matrix} )$$

where δ₁=(1,0), δ₂(0,1), m=(m₁,m₂), n=(n₁,n₂), vᵢ and v_{i,j}, are the entries of the vector v⁰ and the 2×2 matrix v¹, respectively.

Similarly, for the luminance variation component, the following polynomial model is used:
l(x)≈au(x)+b+(a¹u(x)+b¹)·x. (42)

Note that b represents an overall luminance shift and a represents a spatially homogeneous luminance amplification. This leads to the following expression for H_{L,p,f}^{lum} and l
H_{L,p,f}^{lum}=(q_{L,p,f}^{0,0,0},q_{L,p,f}^{1,0,0},q_{L,p,f}^{0,0,δ}^{₁},q_{L,p,f}^{0,0,δ}^{₂},q_{L,p,f}^{1,0,δ}^{₁},q_{L,p,f}^{1,0,δ}^{₂}) (43)
and
l=(b,a,b₁,b₂,a₁,a₂)^{T} (44)
where a¹=(a₂,a₂), b¹=(b₁, b₂)

### Recursive Filters

By selecting a frequency set F and stacking the corresponding equations (39) (for a given L and p) one obtains the image dynamics equation:

$$\frac{\partial }{\partial t} {q}_{L , p , F} ( t ) = {H}_{L , p , F} ( t ) {ϕ}_{L , p , F} ( t ) + noise , \qquad ( 45 )$$

where H_{L,p,F}(t) is the matrix obtained by stacking the row vectors H_{L,p,f}(t) and φ_{L,p,F}(t) (which is obtained by combining the column vectors φ_{L,p,f}(t)) is the time-varying vector of image change descriptors for the block specified by L, p, F.

Well-known methods such as Kalman filters and extended Kalman filters can be used to estimate the descriptors φ_{L,p,F}(t) and to calculate associated errors covariance matrices. One parameter used by these algorithms is a time constant τ which determines for how long information is integrated. If τ is small then the filter is able to track faster changes but is less resilient to noise.

Another parameter used in some embodiment of the invention, denoted μ, identifies the particular model used. For example, different models are obtained by varying the degree of the polynomial functions used to approximate v(x,t) and l(x,t). Embodiments of the invention utilize, for each block L, p, F, a plurality of estimators specified by different values of the parameters τ and μ, yielding a plurality of descriptors φ_{L,p,F}^{μ,τ}(t).

The parameter τ is very important to discriminate fast-changing image aberrations, such as those due to turbulence of the propagation medium, from image changes due to genuine image motion and luminance variations. Indeed, turbulence-induced image aberrations usually occur at a time scale τ^{turb} that is typically smaller than the time scale of genuine image variations. Thus, the effect of fast-changing aberrations can be filtered out by selecting values of τ larger than τ^{turb}.

### Flowchart

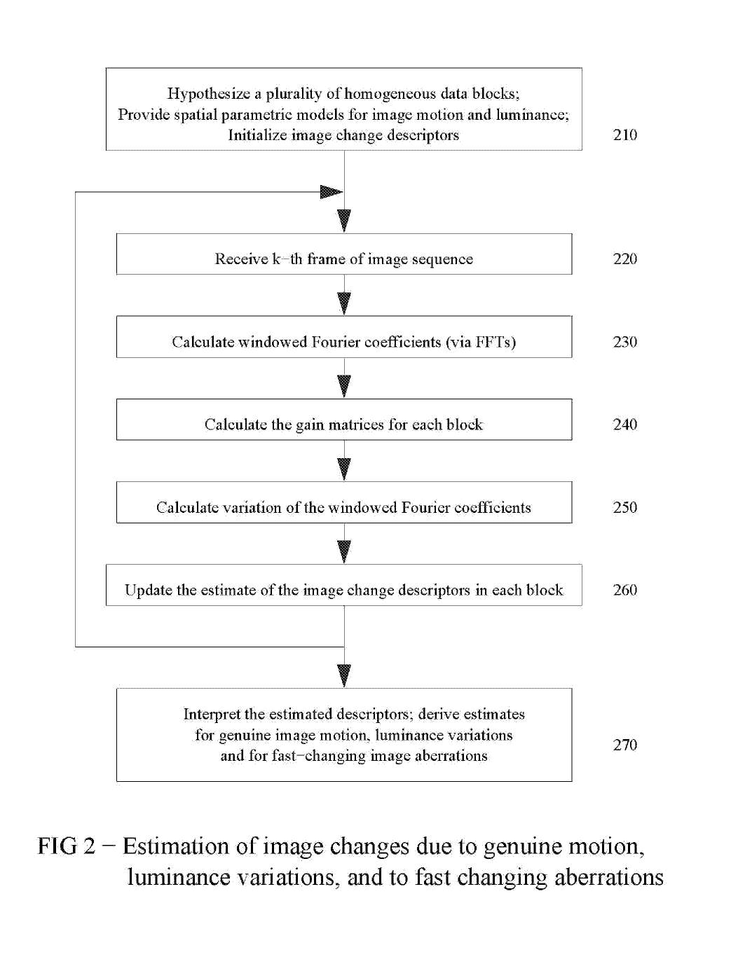

FIG. 2 illustrates this embodiment of the invention in flowchart form. The setup step 210 performs the following tasks:
select a plurality of image regions, similarly to the step 120 of FIG. 1 (except that step 120 also determines a time interval T);
select a plurality of frequency regions F, which along with the selected image regions yields a plurality of hypothesized homogeneous blocks;
provides one or more parametric models for image changes such as (36) and (42);
initialize the descriptors φ_{L,p,F} for each hypothesized block.

At step 220, the k-th frame of the image sequence, o_{•,•,k}, is received. (If k=1 then this step is repeated and k is incremented).

At step 230, the Fourier coefficients q_{L,p,f}^{s,m,n}(k) defined in (40) are calculated (typically, via FFTs).

Step 240 forms the matrices H_{L,p,F}(k) (see (39),(41),(43)) for each of the hypothesized homogeneous block and calculates (or updates) the gain matrices of the estimators for the descriptors φ_{L,p,F}^{μ,τ}(k), according to methods well known to those skilled in the art.

More elaborate embodiments may reduce the computational load by maintaining a dynamic list of image regions of interest (and more generally of the hypothesized homogeneous blocks) and by calculating the coefficients q_{L,p,f}^{s,m,n}(k), the matrices H_{L,p,F}(k) and the other related quantities only for these regions of interest.

At step 250, an estimate of the left hand side of (39) for t=k is obtained as follows:

$$\frac{\partial }{\partial t} {q}_{L , p , f} ( t ) \approx {q}_{L , p , f}^{1 , 0 , 0} ( k ) - {q}_{L , p , f}^{1 , 0 , 0} ( k - 1 ) . \qquad ( 46 )$$

At step 260, for each hypothesized block, a recursive algorithm is used to update the estimate of the image change descriptor, to yield φ_{L,p,F}^{μ,τ}(k) and the associated error covariance matrices. Only values of the parameters for which the error covariance is sufficiently small are retained.

Step 270 identifies and estimates image changes of different types. To estimate fast-changing image aberrations:
small values of the parameter τ are used (e.g. τ≦τ^{turb});
small frequency regions F are used;
the image motion coefficients from the estimated descriptor φ_{L,p,F}^{μ,τ}(k) are extracted and the resulting motion estimate is interpreted as random displacements caused by fast-changing aberrations (e.g., due to atmospheric turbulence);
the luminance coefficients from the estimated descriptor φ_{L,p,F}^{μ,τ}(k) are extracted and the resulting variations are interpreted as amplitude variations caused by fast-changing aberrations.

To estimate genuine image motion and luminance changes:
estimators with a value of τ larger than the time scale of fast-changing image aberrations is selected;
large frequency regions are selected, for example, F=F^{max}(L);
the image motion and luminance coefficients are extracted from the estimated descriptor and are interpreted as being caused by genuine physical phenomena.
   If the data is known to be free of fast-changing aberrations then a small value of τ can be used to estimate genuine image changes so as to achieve higher temporal resolution.

### REFERENCES

[1] S. S. Beauchemin and J. L. Barron. The computation of optic flow. ACM Computing Surveys, 27(3):433-467, 1995.
[2] Michael C. Roggemann, Byron Welsh. Imaging through Turbulence. CRC Press.
[3] Carrano, Carmen J. (Lawrence Livermore National Lab.). Speckle imaging over horizontal paths. Proceedings of SPIE—The International Society for Optical Engineering, v 4825, 2002, p 109-120.
[4] S. G. Gibbard, B. Macintosh, D. Gavel, et. al. “Titan: High-Resolution Speckle Images for the Keck Telescope” Icarus, 139, 189-201, (1999).
[5] Carmen J. Carrano, James M. Brase Adapting high-resolution speckle imaging to moving targets and platforms. SPIE, Orlando, Fla., Apr. 12-16 2004.
[6] G. R. Ayers, M. J. Northcott, and J. C. Dainty. Knox-Thompson and triple-correlation imaging through atmospheric turbulence. JOSA, Vol 5, No. 7, pag. 963, July 1988.
[7] Mikhail A. Voronstov and Gary W. Carhart. Anisoplanatic imaging through turbulent media: image recovery by local information fusion from a set of short-exposure images. JOSA, Vol 18, No. 6. June 2001.
[8] Fraser, Donald (Univ of New South Wales); Thorpe, Glen; Lambert, Andrew. Atmospheric turbulence visualization with wide-area motion-blur restoration. Journal of the Optical Society of America A: Optics and Image Science, and Vision, v 16, n 7, 1999, p 1751-1758.
[9] Leonid P Yaroslavsky, Barak Fishbain, Alex Shteinman, Shai Gepshtein. Processing and Fusion of Thermal and Video Sequences for Terrestrial Long Range Observation Systems.
[10] David H. Frakes, Joseph W. Monaco, Mark J. T. Smith. Suppression of Atmospheric Turbulence in Video Using an Adaptive Control Grid Interpolation Approach. IEEE ICASSP 2001.
[11] D. Korff. Analysis of a method for obtaining near-diffraction limited information in the presence of atmospheric turbulence. J. Opt. Soc. Am., 63, 971-980 (1973)

1. A method to estimate time-varying image aberrations, comprising:
providing an image data sequence;
decomposing said image data sequence into a plurality of space-time data blocks;
calculating a plurality of transform coefficients for each space-time data block;
grouping said transform coefficients into a plurality of hypothesized homogeneous blocks;
providing an underlying image model wherein said image aberrations are described by a time-varying displacement vector in each hypothesized homogeneous block;
calculating an estimate of said displacement vector, to yield an estimate of said image aberrations.

2. A method to jointly estimate time-varying image aberrations, genuine image motion and genuine luminance changes, comprising:
providing an image data sequence;
decomposing each frame of said sequence into a plurality of blocks;
providing a low dimensional parametric model for the image motion and the luminance changes in said blocks;
calculating a plurality of transform coefficients for each block;
grouping said transform coefficients into a plurality of hypothesized homogeneous blocks;
providing an underlying image model wherein the effect of said image aberrations on one of said hypothesized homogeneous blocks is described by a time-varying displacement vector and a time-varying luminance amplification factor;
for each frame in said image data sequence, calculate the variation of each hypothesized homogeneous block from the previous frame and use a recursive linear filter associated with said underlying image model to update a time-varying image change descriptor;
analyze said time-varying image descriptor to estimate image motion, image aberrations and luminance changes.
